(19) United States
(12) Patent Application Publication
(10) Pub. No.: US 2018/0289187 A1
(43) Pub. Date: Oct. 11, 2018

(54) MEASURING DEVICE AND DISPENSING SYSTEM

(71) Applicant: Mead Johnson Nutrition Company, Chicago, IL (US)

(72) Inventor: Margo E. Love, Evansville, IN (US)

(21) Appl. No.: 15/484,450

(22) Filed: Apr. 11, 2017

(51) Int. Cl. A47G 19/34; B67C 11/02; G01F 19/00; B65D 51/24

(52) U.S. Cl. CPC A47G 19/34; B65D 51/24; G01F 19/00; B67C 11/02

(57) ABSTRACT

The present disclosure relates generally to a measuring device comprising an upper body and a lower body. The upper body comprises a chamber having a top opening and a bottom opening, wherein a substance to be measured is placed in the top opening. The lower body fits inside and is slideable relative to the upper body to allow for the measurement of varying amounts of substance. The upper body may attach to a funnel to assist a user in filling the upper body with a substance to be measured, e.g., a powdered substance. The measuring device may be part of a measuring device and containment system.

### TECHNICAL FIELD

The present disclosure relates generally to a measuring device comprising an upper body and a lower body. The upper body comprises a chamber having a top opening and a bottom opening, wherein a substance to be measured is placed in the top opening. The lower body fits inside and is slideable relative to the upper body to allow for the measurement of varying amounts of substance. The upper body may attach to a funnel to assist a user in filling the upper body with a substance to be measured, e.g., a powdered substance. The measuring device may be part of a measuring device and containment system.

### BACKGROUND

Many products exist in granular or powdered form that are stored and sold in containers and must be measured out in appropriate amounts for preparing foods, drinks, etc. These products include infant formula, flour, coffee, sugar and nutritional supplements, such as protein or dietary supplements. Some containers include a measuring device or scoop that allows a user to remove the product from the container, and, in certain circumstances, measure and dispense the amount of product needed for each use.

However, many conventional measuring devices require the user to scoop out and level multiple scoops of powder from a container. Using the prior art methods, the user is constrained to using intervals of the scoop measurement. Thus, a user is unable to precisely measure in-between sizes, risking inaccurate measurements or wasting product.

Further, a user must count out measured scoops of powder to obtain the correct quantity, leading to errors in measurement when the user makes a counting error. Further, the scoop must be leveled each time it is filled to ensure accurate measurements.

Accordingly, there is a need in the art for a measuring device that prevents wasting of product by allowing for in-between measurements. Further, there is a need for a measuring device that does not require the user to keep track of the number of scoops that have been measured, to prevent counting errors and to increase accuracy of measurements.

### BRIEF SUMMARY

The disclosure relates to a measuring device which has an upper body including a chamber having a top opening and a bottom opening at opposite ends of a vertical axis and at least one marking for measuring a substance. The measuring device also includes a lower body having a top end and a bottom end, wherein the lower body is dimensioned to fit inside the upper body, such that when the lower body is fit into the upper body, the lower body is slideable relative to the upper body, and the top end of the lower body is alignable with the at least one marking. Further, the bottom end of the lower body forms or attaches to a base, wherein the base allows the measuring device to stand up on a flat surface.

In certain embodiments, the measuring device also includes a funnel that is removably attached to the top opening of the upper body. In certain embodiments, the funnel is pivotably attached to the upper body.

In certain embodiments, the upper body of the measuring device further comprises a tab longitudinally aligned with the vertical axis, wherein the at least one marking is on the tab. The tab can be integrated in or attached to the upper body. In certain embodiments, the measuring device also includes a funnel, and the tab comprises a pivot or hinge removably attached to the funnel.

In certain embodiments, the measuring device includes a gasket attached to the top end of the lower body. In certain embodiments, the upper body further comprises a grip to facilitate holding and manipulating the measuring device with one hand. In certain embodiments, the top opening of the upper body comprises a lip to reduce spilling when dispensing the substance to be measured.

In certain embodiments, the measuring device is for measuring a powdered pediatric nutritional formula, and the at least one marking indicates the number of ounces of liquid pediatric formula to be made from the powdered nutritional formula.

The disclosure also relates to a containment and measuring system, including a measuring device having an upper body including a chamber having a top opening and a bottom opening at opposite ends of a vertical axis and at least one marking for measuring a substance. The containment and measuring system also includes a lower body having a top end and a bottom end. Also included is a container having a receiving cavity, wherein the receiving cavity is dimensioned to receive the bottom end of the measuring device.

In certain embodiments, the container has a lid, and the receiving cavity is in the lid. In certain embodiments, the containment and measuring system comprises a funnel that is removably attached to the top opening of the upper body. In certain embodiments, the funnel is pivotably attached to the upper body.

In certain embodiments, the upper body further includes a tab longitudinally aligned with the vertical axis, wherein the at least one marking is on the tab. The tab can be integrated in or attached to the upper body. In certain embodiments, the tab comprises a pivot or hinge removably attached to a funnel.

In certain embodiments, a gasket is attached to the top end of the lower body. In certain embodiments, the upper body further comprises a grip to facilitate holding and manipulating the measuring device with one hand. In certain embodiments, the top opening of the upper body comprises a lip to reduce spilling when dispensing the substance to be measured.

In certain embodiments, the measuring device of the containment and measuring system is for measuring a powdered pediatric nutritional formula, and the at least one marking indicates the number of ounces of liquid pediatric formula to be made from the powdered nutritional formula.

The disclosure further relates to a containment and measuring system, wherein the system comprises a plurality of measuring devices and a plurality of containers, each measuring device having a corresponding container to form a plurality of measuring device-container pairs, wherein each measuring device-container pair is specific to a different substance contained within, each measuring device comprising an upper body and a lower body, wherein the lower body comprises a top end and a bottom end, and each container comprises a receiving cavity dimensioned to receive the bottom end of the lower body of its corresponding measuring device, wherein the dimensions of the receiving cavity are unique to the measuring device-container pair.

### BRIEF DESCRIPTION OF THE DRAWINGS

FIG. 1 is a perspective view of a measuring device, showing an upper body, lower body, funnel and lid in unassembled form.

FIG. 2 is a perspective view of a measuring device, showing an upper body, lower body, and funnel in assembled form.

FIG. 3 is a perspective view of a measuring device, showing an assembled funnel, upper body and lower body, wherein the bottom end of the lower body is shaped to fit into a receiving cavity.

FIG. 4 is a perspective view of a measuring device, showing an assembled funnel, upper body and lower body and the lid of a container, wherein the bottom end of the lower body is shaped to fit into a receiving cavity in the lid of a container.

FIG. 5 is a perspective view of a measuring device, showing an assembled upper body and lower body, wherein the upper and lower body are expanded to measure the quantity of powder needed to prepare 7 ounces of infant formula.

FIG. 6 is a perspective view of a measuring device, showing a user dispensing powder from the upper body of the measuring device, wherein the funnel of the measuring device has been rotated away from the top opening of the upper body.

FIG. 7A is a perspective view of a lid including a receiving cavity for the bottom end of the lower body of a measuring device disclosed herein.

FIG. 7B is an elevation view of a container and lid, wherein the lid includes a receiving cavity for the bottom end of the lower body of a measuring device disclosed herein.

### DETAILED DESCRIPTION

Reference now will be made in detail to the embodiments of the present disclosure. It will be apparent to those of ordinary skilled in the art that various modifications and variations can be made to the teachings of the present disclosure without departing from the scope of the disclosure. For instance, features illustrated or described as part of one embodiment, can be used with another embodiment to yield a further embodiment.

Thus, it is intended that the present disclosure covers such modifications and variations as come within the scope of the appended claims and their equivalents. Other objects, features and aspects of the present disclosure are disclosed in or are apparent from the following detailed description. It is to be understood by one of ordinary skill in the art that the present disclosure is a description of exemplary embodiments only and is not intended as limiting the broader aspects of the present disclosure.

For the sake of clarity, not all reference numerals are necessarily present in each drawing Figure. In addition, positional terms such as “upper,” “lower,” “side,” “top,” “bottom,” “vertical,” “horizontal,” etc. refer to the measuring device when in the orientation shown in the drawings. The skilled artisan will recognize that a measuring device can assume different orientations when in use.

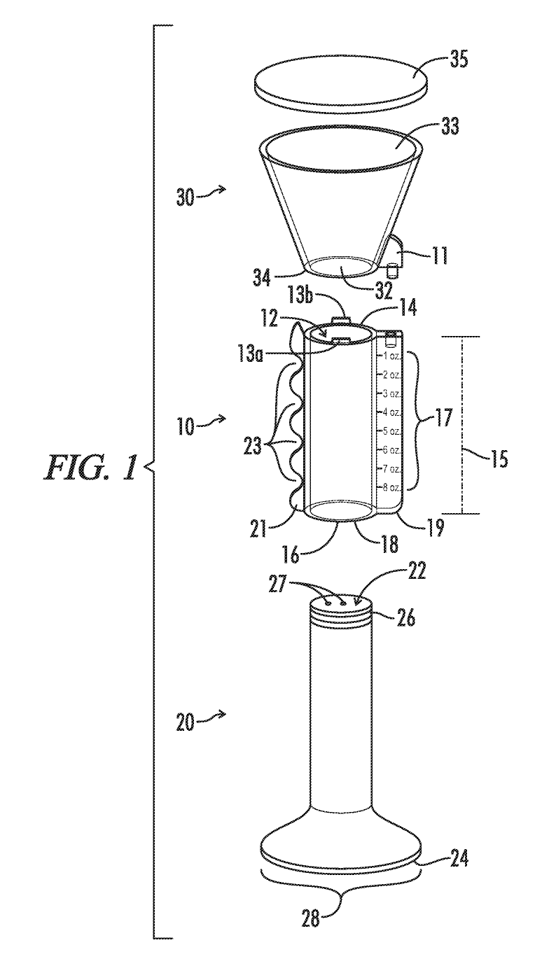

A perspective view of a measuring device is shown in FIG. 1. The measuring device comprises three members: an optional funnel 30, an upper body 10, and a lower body 20. The measuring device is designed to allow a user to insert the lower body 20 into the upper body 10 to a desired setting (e.g., 3 oz.), place a substance to be measured into the funnel 30 until the substance reaches the top of the upper body 10. The user can then level the top of the substance by moving (e.g., sliding or swinging) the funnel 30 away from the upper body 10.

In certain embodiments, the funnel 30, upper body 10 and/or lower body 20 are made of a plastic material such as polypropylene, high density polyethylene, low density polyethylene, polystyrene, polystyrene-acrylonitrile, acrylonitrile-butadiene-styrene, styrene-maleicanhydride, polycarbonate, polyethylene terephthalate, polyvinylcyclohexane, and blends thereof. In certain embodiments, the plastic material is a polymeric resin material. Suitable polymeric materials include high density polyethylene, low density polyethylene, ultra high molecular weight polyethylene, polypropylene, polycarbonate, acrylic, polyvinyl chloride (“PVC”), flexible polyvinyl chloride (“FPVC”), polyurethane, ABS, nylon or polyester, or blends thereof. Preferably, the upper body is translucent or transparent.

The plastic may be antimicrobial plastic or may be covered by an antimicrobial coating. An anti-microbial agent can include any of a number of metal ions exhibiting fungicidal, bactericidal or bacteriostatic activity such as silver, copper, zinc, mercury, tin, lead, bismuth, cadmium, chromium and thallium ions. Without being bound by a particular theory, these antimicrobial metal ions are believed to exert their effects by binding to the cell walls of bacteria and disrupting respiration and electron transport systems upon absorption into the cells. The agent may also interfere with enzyme production stopping the bacterial cell from producing energy. In some aspects, the agent interrupts the bacterial cells' DNA preventing replication. Antimicrobial metal ions of silver, gold, copper and zinc, in particular, are considered safe even for use with nutritional compositions such as infant formulas and children's products. Antimicrobial silver ions are particularly safe for use infant formulas and children's products because they are not substantially absorbed into the body. Accordingly, if such materials are used they should not be hazardous.

In at least one embodiment of the invention, the inorganic antibiotic metal containing composition is an antibiotic metal salt. Such salts include silver acetate, silver benzoate, silver carbonate, silver ionate, silver iodide, silver lactate, silver laureate, silver nitrate, silver oxide, silver palpitate, silver protein, and silver sulfadiazine. Silver nitrate is preferred. Salts of silver are beneficial because they are non-leaching. Accordingly, once it is incorporated into the plastic resin it does not seep out of the resin. Further, the controlled release of the active ingredient, the silver ions, provides antimicrobial protection for the life of the container and its components.

The upper body 10 comprises a hollow tube which preferably is cylindrical, but may be a parallelepiped, triangular prism, etc. In embodiments in which the upper body 10 is cylindrical, the upper body 10 comprises a substantially circular top opening 12 with a circumference 14 and a substantially circular bottom opening 16 with a circumference 18. The top opening and bottom opening are at opposite ends of a vertical axis 15. The upper body 10 may optionally include a grip 21 to facilitate holding and manipulating the measuring device with one hand. The grip may comprise grooves 23 for a user's fingers to prevent slippage when holding and manipulating the measuring device.

The upper body 10 may comprise graduated markings 17 for measuring the substance (e.g., a powder) along the vertical axis 15, which may be, for example, molded into or printed onto the exterior of the upper body. In certain embodiments, such as the one shown in FIG. 1, the graduated markings 17 are molded or printed onto a flat fin-like tab 19 that is integrated in or attached to the upper body 10 and longitudinally aligned with the vertical axis 15. The top of the tab 19 may further connect to a pivot or hinge 11 on the funnel 30, which allows the funnel to rotate away from the top opening 12 of the upper body 10 when the measured substance is dispensed. In certain embodiments (not shown), a lip extends outward from the circumference 18 of the top opening and can engage a receptacle into which the measured substance is being dispensed to prevent spillage of the substance.

The funnel 30 comprises a top opening 33 which optionally may be covered with a cover 35 when not in use. In a preferred embodiment, the top opening 33 is substantially circular, but it may be any shape as long as it functions to funnel the substance to be measured into the top opening 12 of the upper body 10. The plastic may be antimicrobial plastic or may be covered by an antimicrobial coating. The funnel 30 comprises a bottom opening 32 with a circumference 34. The bottom opening 32 of the funnel 30 is substantially the same shape and size as the top opening 12 of the upper body 10.

The circumference 34 of the funnel is substantially the same size as the circumference 14 of the top opening 12 of the upper body. One or more stability members (for example, 13a and 13b as shown in FIG. 1A) may be integrally or otherwise connected around the circumference 14 of the top opening 12 of the upper body to assist in holding the funnel 30 in alignment with the upper body 10 via frictional force when the user is filling the upper body with a substance to be measured. Accordingly, the stability members are large enough to keep the funnel 30 in place while measuring, but small enough to allow the user to push the funnel 30 away from the top opening 12 to dispense the measured substance from the upper body 10. In certain embodiments, the stability members 30 are located no more than about 90 degrees around the circumference 14 from the tab 19.

Alternatively, or in addition to the use of stability members (e.g., 13a and 13b), the funnel 30 may be held in alignment with the upper body 10 by use of a ratcheted pivot, through the frictional force of the pivot, or use of a bi-stable hinge that maintains the funnel 30 either centered over the upper body 10 or rotated fully away from the upper body 10.

The lower body 20 is substantially the same shape (e.g., cylindrical) as and dimensioned to fit inside the upper body 10. The lower body has a top end 22 and a bottom end 24. The top end 22 may attach to or be covered with a gasket 26 to allow a close fit between the upper body 10 and lower body 20. The gasket may be a flexible gasket, such as an over-molded flexible gasket, similar to a drug syringe gasket. The gasket 26 may be of contrasting color to the lower body 20. The gasket 26 may have one or more holes 28 for venting air. The gasket 26 may be made from natural rubber or a rubber-like material such as a thermoplastic elastomer, a highly plasticized thermoplastic elastomer, and silicone.

The bottom end 24 of the lower body 20 may form or be attached to a base 28. The base 28 may be wider than the top end 22 of the lower body 20. The base 28 allows for the measuring device to stand up on a counter or other flat surface.

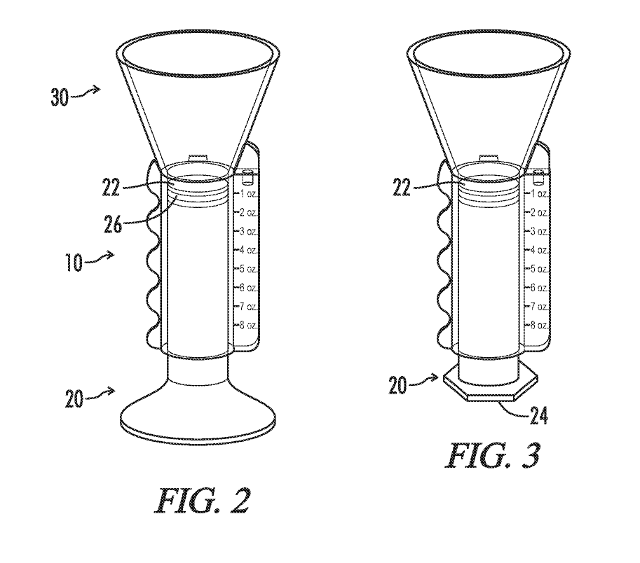

FIG. 2 shows the funnel 30, the upper body 10 and the lower body 20 in assembled form. When the upper body 10 and lower body 20 are assembled, the top end 22 of the lower body 20 (or the gasket 26, if the gasket 26 is attached to the top end 22 of the lower body 20) is visible through the transparent or translucent upper body 10 and can be slideably matched to the desired marking (e.g., on the tab 19).

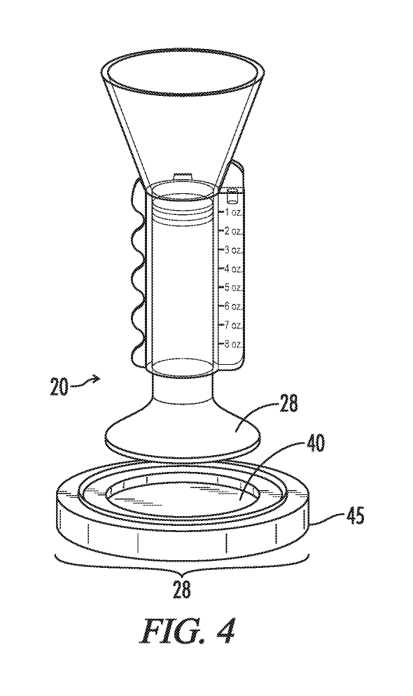

In certain embodiments, as shown in FIG. 3, the bottom end of the lower body 20 forms a shape such as a circle, hexagon, square, etc., which can snap into a receiving cavity of a base (not shown). FIG. 3 depicts the bottom end 24 as having a similar width as the top end 22 of the lower body 20, but in certain embodiments, the bottom end 24 is substantially wider than the top end 22. As shown in FIG. 4, the receiving cavity 40 may be on the lid 45 of a container holding the substance to be measured, or on the body of the container. In this embodiment, the lid 45 forms the base 28.

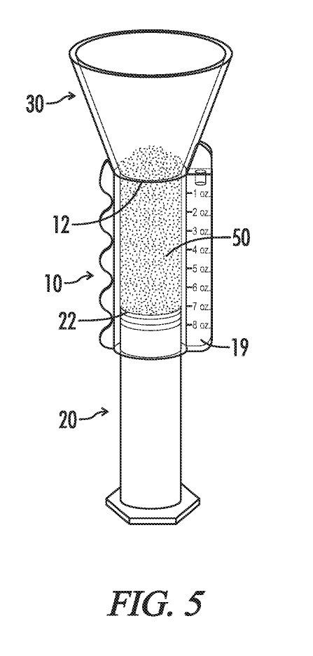

The measuring device can be used to measure any liquid or flowable solid (e.g., powder) substance. FIG. 5 shows an embodiment in which a powder 50 has been transferred from a container into the upper body 10 via the funnel 30 for measuring. The top end 22 of the lower body 20 is aligned with a marking on the tab 19 for the desired amount of powder (e.g., the amount of powder need to make 7 oz. of infant formula). As shown in FIG. 5, the powder can be transferred into the upper body 10 until the powder rises above the top opening 12 and collects in the funnel 30.

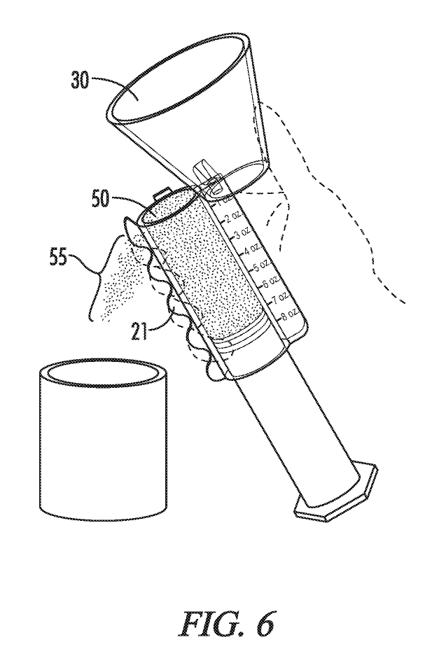

As shown in FIG. 6, a user can rotate the funnel 30 with one hand to level the powder 50, allowing excess powder 55 to fall back into the container from which the substance was transferred. FIG. 6 also depicts the optional grip 21 which facilitates holding and manipulating the measuring device with one hand.

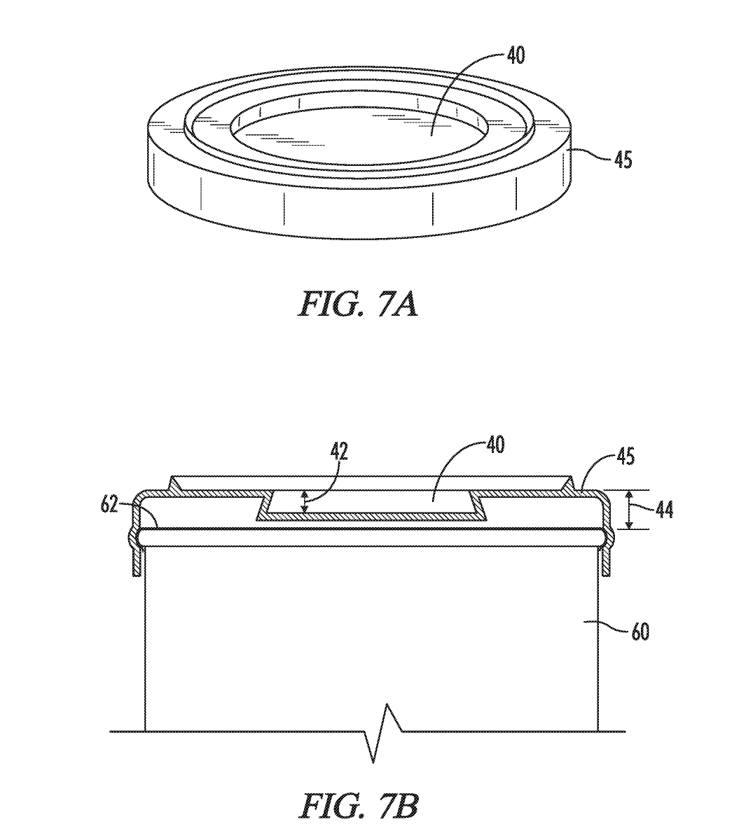

In certain embodiments, the measuring device is part of a containment and dispensing system. FIG. 7A shows a perspective view of a lid 45 having a receiving cavity 40. As shown in the elevation view of FIG. 7B, the containment and dispensing system can comprise a storage container 60 and a lid 45 (e.g., a snap cap, friction fit plug-style closure, threaded screw cap, or any other form of container cover), wherein the lid 45 comprises a receiving cavity 40 to which the bottom end 24 of the lower body 20 (not shown) can be removably attached. The lid has a height 44 sufficient to accommodate the depth 42 of the receiving cavity 40 of the lid 45 above a removeable seal 62 (e.g., a foil seal) on the container which protects the contents of the container. The lid 45 can be placed on a counter or other surface and functions as a base for the measuring device when the measuring device is attached. When the measuring device is not in use, it can be placed into the receiving cavity 40 for storage so as not to take up counter space.

In one embodiment, a system for measuring a series of different types of products (e.g., granular or powdered products) is provided, wherein each type of product is paired with a measuring device using a distinctive shape at the bottom end 24 of the lower body 20 to ensure that the correct measuring device is used with its corresponding substance.

The use of distinctive shapes ensures that the correct device is used for a given powder, because the wrong measuring device will not fit into the receiving cavity 40 of the lid 45 for that powder. The use of distinctive shapes is advantageous for preventing inaccurate measuring and cross-contamination of measuring devices.

In certain embodiments, the measuring device is provided in the same packaging as the container holding the substance to be measured. In other embodiments, the measuring device is provided in separate packaging and is useable from container to container of a given substance.

In certain embodiments, the substance to be measured is granular, for example, a powder. Granular or powdered substances include, amongst other things, flour, coffee, sugar and nutritional supplements, such as protein or dietary supplements. In certain embodiments, the substance to be measured is a powdered pediatric nutritional formula, such as an infant formula or growing-up milk.

Prior art methods of measuring granular or powdered substances (e.g., pediatric nutritional formulas) require the user to scoop out and level multiple scoops from a container. Using the prior art methods, the user is constrained to using intervals of the scoop measurement. In contrast, the measuring device as disclosed herein allows for the measurement of individualized amounts to match a user's needs without wasting the granular or powdered substance. This allows the user to precisely measure in-between sizes, e.g., the exact equivalent of 2½ scoops. For example, a user can measure an individualized feeding amount to match an infant or child's needs without wasting nutritional formula. Further, the measuring device is only leveled once, unlike a scoop which must be leveled with each scoop for accurate measurements.

Further, the measuring device described herein does not require the user to count out measured scoops of powder (or other substance) to obtain the correct quantity as in prior art methods. Rather, using the measuring device described herein, the user can easily visualize when the correct amount of powder has been transferred from its container, preventing errors in measurement that occur with the prior art when the user makes a counting error.

In certain embodiments, the measuring device described herein provides for hygienic handling because it does not contact the powder as it is stored in the container, preventing potential contamination of the stored powder. Further, a cover for the funnel or upper body can be used to maintain the hygiene of the interior of the device. In addition, the measuring device can be made using antimicrobial materials, if desired. In certain embodiments, the measuring device is washable, and in a preferred embodiment, the measuring device is dishwasher-safe.

In certain embodiments, the measuring device is part of a containment and dispensing system for pediatric nutritional formulas, such as infant formula and growing-up milk. “Infant formula” as used herein means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to simulate the nutritional and other properties of human breast milk.

The term “growing-up milk” refers to a broad category of nutritional compositions intended to be used as a part of a diverse diet to support the normal growth and development of a child between the ages of about 1 and about 6 years of age.

In certain embodiments, the circumference of the top end of the upper body is smaller than the circumference of the neck of a baby bottle. For example, the circumference of the top end of the upper body can be less than about 45 mm, less than about 42 mm, less than about 40 mm, less than about 38 mm, or less than about 36 mm. In certain embodiments, a lip extends outward from the circumference of the top opening of the upper body, which can engage a baby bottle preventing infant formula powder from being spilled when it is dispensed into the bottle.

In one embodiment, a series of different types of pediatric nutritional formulas are provided, and each type of formula is paired with a measuring device using a distinctive shape at the bottom end of the lower body to ensure that the correct measuring device is used with its corresponding formula. For example, a soy formula may correspond to a circular shape, a hydrolyzed formula may correspond to a square shape, a growing-up milk may correspond to a hexagon, etc. The use of distinctive shapes ensures that the correct device is used for a given powder, because the wrong measuring device will not fit into the receiving cavity 40 of the lid 45. The use of distinctive shapes is advantageous for preventing inaccurate measuring and cross-contamination, for example, in households, day care centers, hospitals, etc. where more than one type of pediatric nutritional formula is used.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. Therefore, the spirit and scope of the appended claims should not be limited to the description of the versions contained therein.

Thus, although there have been described particular embodiments of the present invention of a new and useful measuring device, it is not intended that such references be construed as limitations upon the scope of this invention except as set forth in the following claims.

What is claimed is:

1. A measuring device comprising:
an upper body comprising a chamber having a top opening and a bottom opening at opposite ends of a vertical axis, the upper body further comprising at least one marking for measuring a substance,
a lower body having a top end and a bottom end, wherein the lower body is dimensioned to fit inside the upper body,
wherein when the lower body is fit into the upper body, the lower body is slideable relative to the upper body, and the top end of the lower body is alignable with the at least one marking, and
wherein the bottom end of the lower body forms or attaches to a base, wherein the base allows the measuring device to stand up on a flat surface.

2. The measuring device of claim 1, further comprising a funnel, wherein the funnel is removably attached to the top opening of the upper body.

3. The measuring device of claim 2, wherein the funnel is pivotably attached to the upper body.

4. The measuring device of claim 1, wherein the upper body further comprises a tab longitudinally aligned with the vertical axis of the upper body, wherein the at least one marking is on the tab.

5. The measuring device of claim 4, wherein the measuring device further comprises a funnel, and the tab comprises a pivot or hinge removably attached to the funnel.

6. The measuring device of claim 1, further comprising a gasket attached to the top end of the lower body.

7. The measuring device of claim 1, wherein the upper body further comprises a grip to facilitate holding and manipulating the measuring device with one hand.

8. The measuring device of claim 1, wherein the top opening of the upper body comprises a lip to reduce spilling when dispensing the substance to be measured.

9. The measuring device of claim 1, wherein the device is for measuring a powdered pediatric nutritional formula, and the at least one marking indicates the number of ounces of liquid pediatric formula to be prepared from the powdered nutritional formula.

10. A containment and measuring system, comprising:
(a) a measuring device comprising:
an upper body comprising a chamber having a top opening and a bottom opening at opposite ends of a vertical axis, the upper body further comprising at least one marking for measuring a substance, and
a lower body, wherein the lower body has a top end and a bottom end;
and
(b) a container having a receiving cavity, wherein the receiving cavity is dimensioned to receive the bottom end of the measuring device.

11. The containment and measuring system of claim 10, wherein the container comprises a lid, and the receiving cavity is in the lid.

12. The containment and measuring system of claim 10, further comprising a funnel, wherein the funnel is removably attached to the top opening of the upper body.

13. The containment and measuring system of claim 12, wherein the funnel is pivotably attached to the upper body.

14. The containment and measuring system of claim 10, wherein the upper body further comprises a tab longitudinally aligned with the vertical axis, wherein the at least one marking is on the tab.

15. The containment and measuring system of claim 14, wherein the measuring device further comprises a funnel, and the tab comprises a pivot or hinge removably attached to the funnel.

16. The containment and measuring system of claim 10, further comprising a gasket attached to the top end of the lower body.

17. The containment and measuring system of claim 10, wherein the upper body further comprises a grip to facilitate holding and manipulating the measuring device with one hand.

18. The containment and measuring system of claim 10, wherein the top opening of the upper body comprises a lip to reduce spilling when dispensing the substance to be measured.

19. The containment and measuring system of claim 10, wherein the device is for measuring a powdered pediatric nutritional formula, and the at least one marking indicates the number of ounces of liquid pediatric formula to be prepared from the powdered nutritional formula.

20. A containment and measuring system, wherein the system comprises:
a plurality of measuring devices and a plurality of containers,
each container comprising a different substance, and
each measuring device having a corresponding container to form a plurality of measuring device-container pairs, wherein each measuring device-container pair is specific to the substance contained within the container,
each measuring device comprising an upper body and a lower body, wherein the lower body comprises a top end and a bottom end, and
each container comprises a receiving cavity dimensioned to receive the bottom end of the lower body of its corresponding measuring device, wherein the dimensions of the receiving cavity are unique to the measuring device-container pair.
